(19) United States
(12) Patent Application Publication
(10) Pub. No.: US 2017/0113412 A1
(43) Pub. Date: Apr. 27, 2017

(54) System and method for printing a three-dimensional object incorporating an image

(71) Applicant: Adamation, LLC, Oakland, CA (US)

(72) Inventor: Stephan Adams, Oakland, CA (US)

(21) Appl. No.: 14/919,805

(22) Filed: Oct. 22, 2015

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

A method for printing a three-dimensional object incorporating an image includes receiving, by a first computing device coupled to a rapid prototyping device, a two-dimensional image file, merging, by the first computing device, the two dimensional image file with a file representing a three-dimensional object, producing a three-dimensional print file and printing, by the first computing device, using the rapid prototyping device, the three-dimensional print file.

### TECHNICAL FIELD

This invention relates to producing objects using a rapid prototyping process. More particularly, the present invention relates to printing a three-dimensional object incorporating an image.

### BACKGROUND ART

The photo merchandise market will reach $2.2 billion in revenues by 2015, and personal media is the top market segment for mass customization offerings. As a result, consumers will crave and expect more customized and personalized products. Traditional methods for producing personalized media involve incorporating conventionally printed photographs in keychains or lockets, or printing customized photographs on the exterior of consumer items such as mugs. These methods generally do not provide the consumer with many options for customizing design. The resultant products often lack style and durability

In view of the above, there is a need for a convenient and flexible way to produce personalized memorabilia.

### SUMMARY OF THE EMBODIMENTS

In one aspect, a method for printing a three-dimensional object incorporating an image includes receiving, by a first computing device coupled to a rapid prototyping device, a two-dimensional image file. The method includes merging, by the first computing device, the two-dimensional image file with a file representing a three-dimensional object, producing a three-dimensional print file. The method includes printing, by the first computing device, using the rapid prototyping device, the three-dimensional print file to produce a three-dimensional product.

In a related embodiment, receiving further involves receiving, from a digital camera coupled to the first computing device, the two-dimensional image file. In another embodiment, receiving further includes receiving, from a second computing device, the two-dimensional image file.

In an additional embodiment, merging also involves producing a three dimensional print file in which the two dimensional image is projected onto an exterior surface of the three dimensional object. In yet another embodiment, merging further includes producing a three-dimensional print file in which a text string is projected onto an exterior surface of the three dimensional object. In another embodiment still, the text string varies topographically from the surface. In a related embodiment, the text string stands out in relief on the surface. In another related embodiment, the text string is engraved within the surface. In an additional embodiment, the three-dimensional print file depicts an object having at least two colors.

In an additional embodiment, printing further involves printing an object having at least two colors. A further embodiment involves merging a second two-dimensional image file with the three-dimensional print file. Another embodiment involves adding at least one textural element to the three-dimensional print file. In still another embodiment, the at least one textural element includes a picture frame. In yet another embodiment, the at least one textural element includes a relief design. In a further embodiment, the at least one textural element also includes at least two colors. Another embodiment also involves adding at least one pattern of two or more colors to the three-dimensional print file. Another embodiment further involves applying a coating layer to an exterior surface of the three-dimensional product.

In another aspect, a system for printing a three-dimensional object incorporating an image includes a rapid prototyping device. The system includes a first computing device coupled to the rapid prototyping device, the first computing device configured to receive a two dimensional image file, to merge the two dimensional image file with a file representing a three dimensional object, producing a three dimensional print file, and to print, using the rapid prototyping device, the three dimensional print file.

In a related embodiment, the rapid prototyping device includes an additive device. In another embodiment, the additive device includes a three-dimensional color printer.

Other aspects, embodiments and features of the disclosed system and method will become apparent from the following detailed description of the system and method when considered in conjunction with the accompanying figures. The accompanying figures are for schematic purposes and are not intended to be drawn to scale. In the figures, each identical or substantially similar component that is illustrated in various figures is represented by a single numeral or notation at its initial drawing depiction. For purposes of clarity, not every component is labeled in every figure. Nor is every component of each embodiment of the device and method is shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a block diagram depicting an example of an computing device as described herein;

FIG. 1B is a block diagram of a network-based platform, as disclosed herein;

FIG. 2 is a block diagram of an embodiment of the disclosed system;

FIG. 3A is a flow diagram illustrating one embodiment of the disclosed method;

FIG. 3B is a schematic diagram depicting an embodiment of an object described in three-dimensional print file;

FIG. 3C is a schematic diagram depicting an embodiment of an object described in three-dimensional print file;

FIG. 4A is an exemplary workflow illustrating one embodiment of the disclosed method; and

FIG. 4B is an exemplary workflow illustrating one embodiment of the disclosed method.

### DETAILED DESCRIPTION OF SPECIFIC EMBODIMENTS

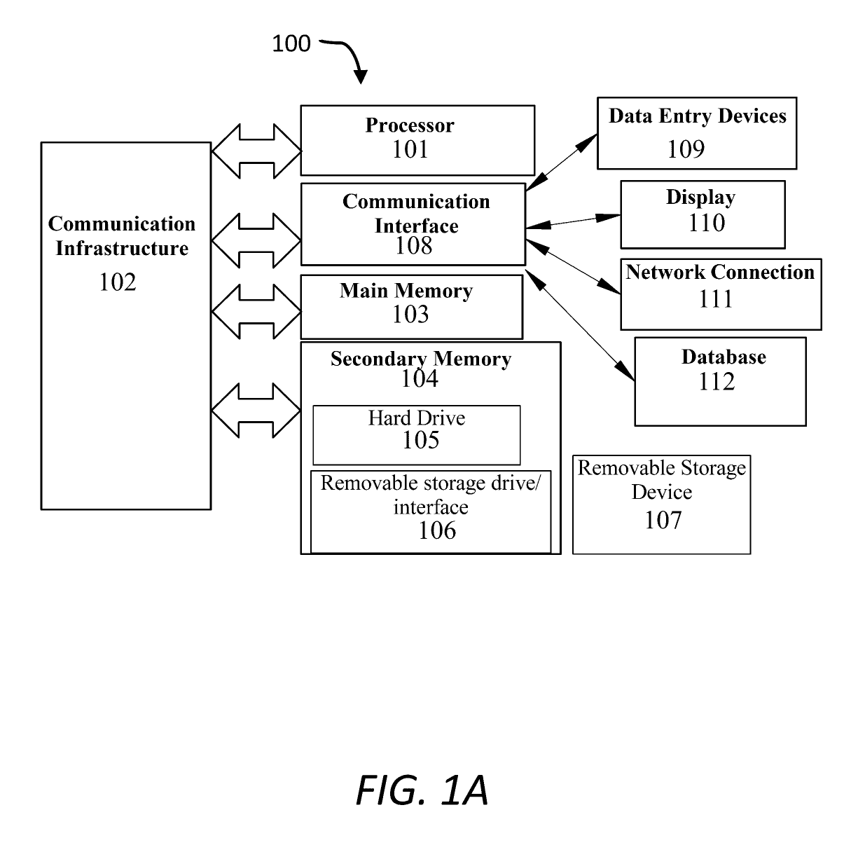

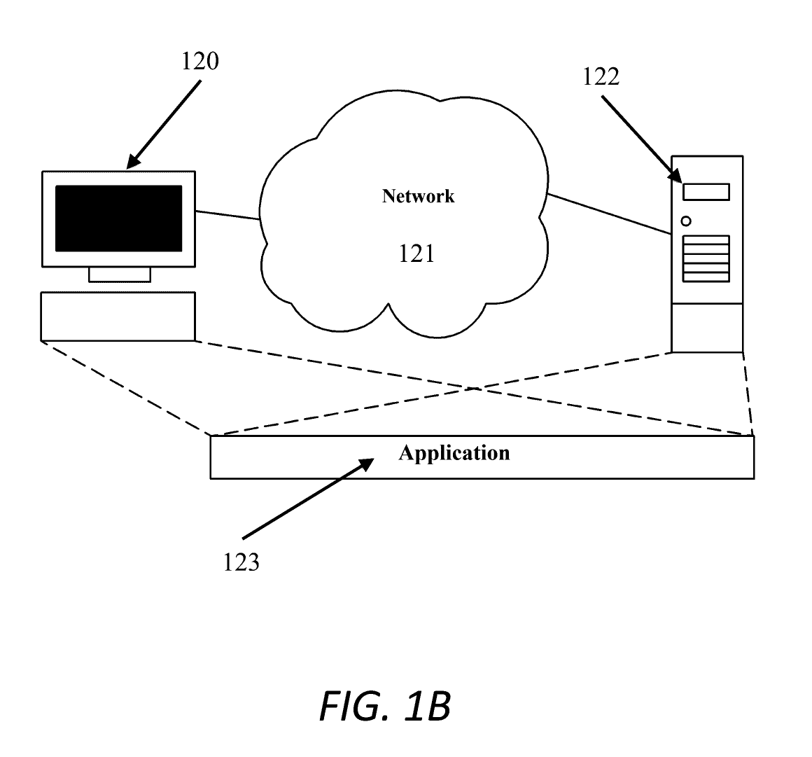

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The computing device 100 may employ one or more security measures to protect the computing device 100 or its data. For instance, the computing device 100 may protect data using a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above. In one embodiment, the client 120 and server 122 exchange the data using public key cryptography; for instance, the client and the server 122 may each generate a public and private key, exchange public keys, and encrypt the data using each others' public keys while decrypting it using each others' private keys.

In some embodiments, the client 120 authenticates the server 122 or vice-versa using digital certificates. In one embodiment, a digital certificate is a file that conveys information and links the conveyed information to a “certificate authority” that is the issuer of a public key in a public key cryptographic system. The certificate in some embodiments contains data conveying the certificate authority's authorization for the recipient to perform a task. The authorization may be the authorization to access a given datum. The authorization may be the authorization to access a given process. In some embodiments, the certificate may identify the certificate authority.

The linking may be performed by the formation of a digital signature. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. The digital signature may be incorporated in a digital certificate, which is a document authenticating the entity possessing the private key by authority of the issuing certificate authority, and signed with a digital signature created with that private key and a mathematical representation of the remainder of the certificate. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

The server 122 and client 120 may communicate using a security combining public key encryption, private key encryption, and digital certificates. For instance, the client 120 may authenticate the server 122 using a digital certificate provided by the server 122. The server 122 may authenticate the client 120 using a digital certificate provided by the client 120. After successful authentication, the device that received the digital certificate possesses a public key that corresponds to the private key of the device providing the digital certificate; the device that performed the authentication may then use the public key to convey a secret to the device that issued the certificate. The secret may be used as the basis to set up private key cryptographic communication between the client 120 and the server 122; for instance, the secret may be a private key for a private key cryptographic system. The secret may be a datum from which the private key may be derived. The client 120 and server 122 may then uses that private key cryptographic system to exchange information until the in which they are communicating ends. In some embodiments, this handshake and secure communication protocol is implemented using the secure sockets layer (SSL) protocol. In other embodiments, the protocol is implemented using the transport layer security (TLS) protocol. The server 122 and client 120 may communicate using hyper-text transfer protocol secure (HTTPS).

Embodiments of the disclosed system and methods merge custom modeled art with two-dimensional images. The merged item may have customizable frame and text options. The user may select the modeled art, frame, frames, and text. In some embodiments, the disclosed system and methods enable the easy and durable production of consumer goods such as keepsakes, ornaments, novelties, memorabilia, three-dimensional greeting cards/placards, table center pieces, wall reliefs, trophies, jewelry, and event favors.

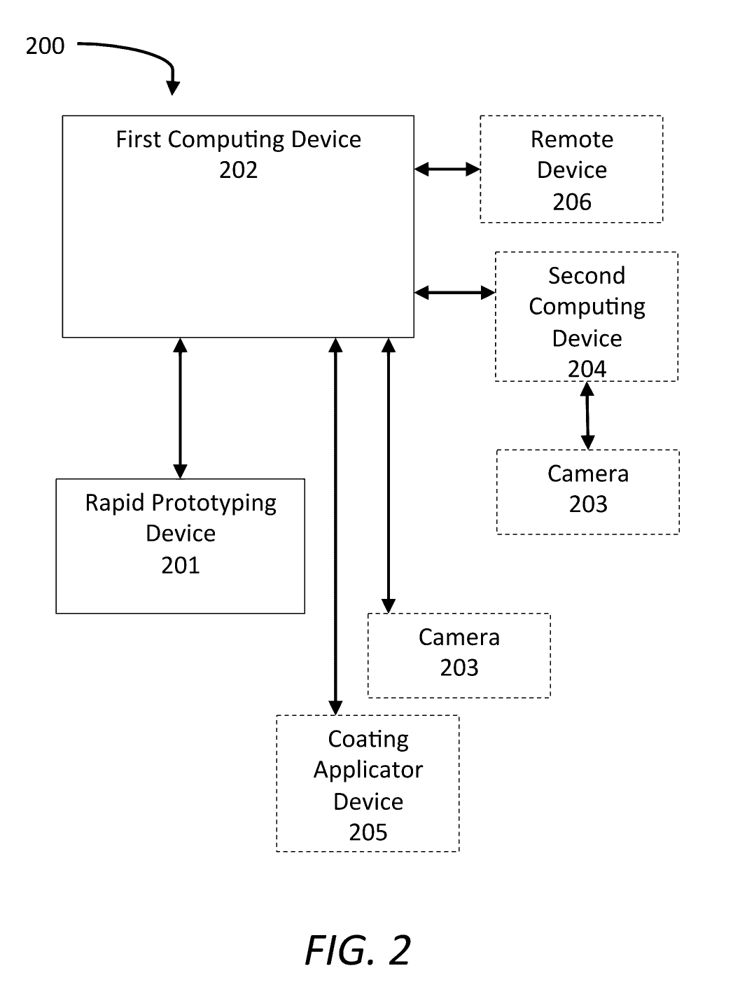

FIG. 2 illustrates an embodiment of a system 200 for printing a three-dimensional object incorporating an image. As an overview, the system 200 includes a rapid prototyping device 201. The system 200 includes a first computing device 202 coupled to the rapid prototyping device 201.

Referring to FIG. 2 in further detail, the system 200 includes a rapid prototyping device 201. In some embodiments, the rapid prototyping device 201 is a device that receives data concerning a three-dimensional object from a computing device and transforms one or more materials to produce the three-dimensional object. In some embodiments, the rapid prototyping device 201 includes an additive device. The additive device may be any device that builds part or all of the three-dimensional object by joining together material in incremental steps. For instance, the additive device may deposit a series of horizontal layers of material, where each layer in the series corresponds to a cross-sectional layer of the object having a width equal to the width of a layer; thus, for instance, a cylinder may be created by repeatedly depositing discs having the same radius as the cylinder until the stack of discs is substantially the same height as the cylinder.

The layers of material may be deposited in any way usable for deposition of layers in an additive rapid prototyping device, rapid prototyping device, or three-dimensional printer. In some embodiments, the layers are deposited in liquid form and hardened through procedures such as drying, cooling, or curing; the same procedures may serve to adhere each layer to the preceding layer, or to merge two layers together. The liquid may combine solid and fluid elements and behaviors; for instance, the liquid may be a non-Newtonian fluid, a viscoelastic material that behaves as a fluid when subjected to a particular pressure, or a slurry of solid and liquid elements that behaves as a fluid under the correct circumstances. As a non-limiting example, the additive rapid prototyping device may employ digital light processing rapid prototyping, in which a layer of resin corresponding to one of a plurality of thin cross-sections of the three dimensional model is deposited and then cured by light that is protected according to the form of the corresponding cross-section in the model; a subsequent layer may be then deposited and cured according to the next cross-section of the model. As another non-limiting example, the additive rapid prototyping device may use stereolithography, wherein a deposited layer of resin corresponding to a cross-section of the three-dimensional model is cured using lasers, such as ultraviolet lasers, before the deposition of a subsequent layer of resin.

In other embodiments, the layers are deposited in the form of a powder or other collection of pieces of substantially solid material, which are bound together by an additional process; for instance, where the solid material is metal, it may be bound together and to the previous layer by a laser sintering process. Alternatively, the solid materials may be combined with a binding agent; the binding agent may be sprayed or otherwise deposited on each layer before or after the deposition of the solid material, or the solid material and binding agent may be deposited simultaneously. As a non-limiting example, the additive rapid prototyping device may employ a “powder bed and inkjet” printing process, in which the part to be printed is built up from many thin cross-sections of the three-dimensional model; continuing the example, an inkjet printer head may move across the powder layer, selectively depositing a liquid binding material as dictated by the current cross-section of the 3D model, and layer of powder may then be deposited matching the thickness of one of the cross-sections, so that the powder sticks to the object, forming a new layer only where the binder was applied. In this way, the process may traverse through the cross-sections of the 3D model from the bottom to the top, producing an object that is the sum of the cross-sections. Upon conclusion, the process may also involve removing powder in what is sometimes called “de-powdering.” The powder may be reused in future processes. Other treatments of the produced part may follow, such as the introduction of further materials or other processes to produce a particular characteristic in the finished part.

The rapid prototyping device 201 may include a three-dimensional color printer. In some embodiments, a three-dimensional color printer is a rapid prototyping device that can deposit two or more distinct colors when adding to the object the rapid prototyping device is producing; as a result, the three-dimensional color printer may be able to permit a computing device to specify the color of each portion of the object being produced, in a manner analogous to the control over colors offered by a color printer that prints paper or two-dimensional photographs. The three-dimensional color printer may be capable of depositing a plurality of distinct colors; for instance, the three-dimensional color printer may have three or more materials that together cover the three wavelengths perceptible by most human eyes, such that the materials may be combined to simulate any color that an ordinary person is capable of perceiving. In some embodiments, color is added by using print heads that deposit various colored binder materials, combined according to the colors in the three-dimensional model, for instance according to the cyan, magenta, yellow and key (CMYK) protocol. As a non-limiting example, the three-dimensional color printer may include a PROJET three-dimensional printer as produced by 3D Systems Inc. of Rock Hill, S.C. or a CONVEX SYSTEM from Stratasys Inc. of Israel or a similar product.

In some embodiments, the system 200 includes a coating applicator device 205. The coating applicator device 205 may be a device that can apply one or more layers of coating to an exterior surface of an object produced by the rapid prototyping device 201. The coating applicator device 205 may have one or more components that apply a coating liquid, resin, or powder; for instance, the one or more components may include nozzles or brushes for applying liquid or resin onto the exterior surface. The liquid or resin may cure by drying or cooling on the object; the liquid or resin may be curable by heat or by electromagnetic radiation such as ultraviolet radiation, or both. As another example, the one or more components may include devices for electrostatic application of powders for powder coating.

The coating applicator device 205 may include one or more components for curing or otherwise finishing a coating surface, such as an ultraviolet light for ultraviolet curing of a UV-curable resin. The components for curing may include components that generate heat for heat-curable powders or resins. The components for curing may include one or more additional applicators to apply substances that combine chemically with the coating substance to cure it. The components for curing may cure by a combination of methods; for instance, the components for curing may include an ultraviolet curing oven, which combines UV light bulbs and heat to cure parts; in some embodiments an ultraviolet curing oven requires lower temperatures than traditional thermal plastic curing techniques, which may destabilize liquid adhesives used in post processing in some embodiments.

The coating applicator device 205 may be incorporated in the rapid prototyping device 201; for example, the rapid prototyping device 201 may include the components of the coating applicator device 205 within the rapid prototyping device 201. In other embodiments, the coating applicator device 205 is linked to the rapid prototyping device 201 by an automated conveyor (not shown), such as a conveyor belt. The coating applicator device 205 and rapid prototyping device 201 may be incorporated together in a larger apparatus such as a kiosk or workstation. In other embodiments, the coating applicator device is a separate apparatus or set of apparatuses used in a production process; for instance, the three-dimensional product may be coated manually and inserted in an oven for curing.

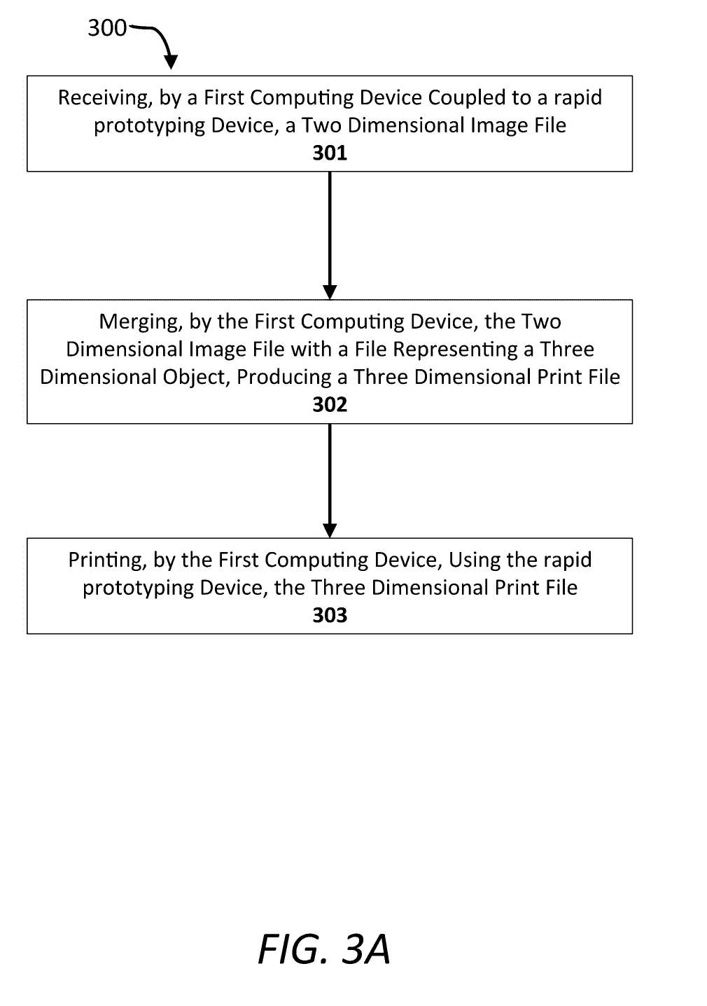

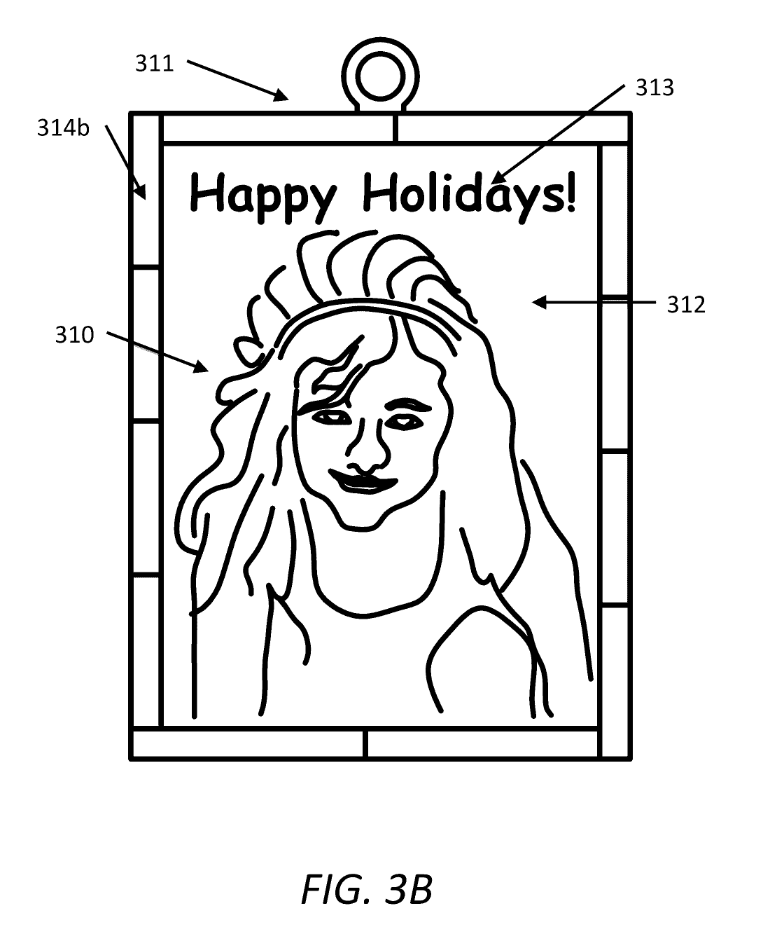

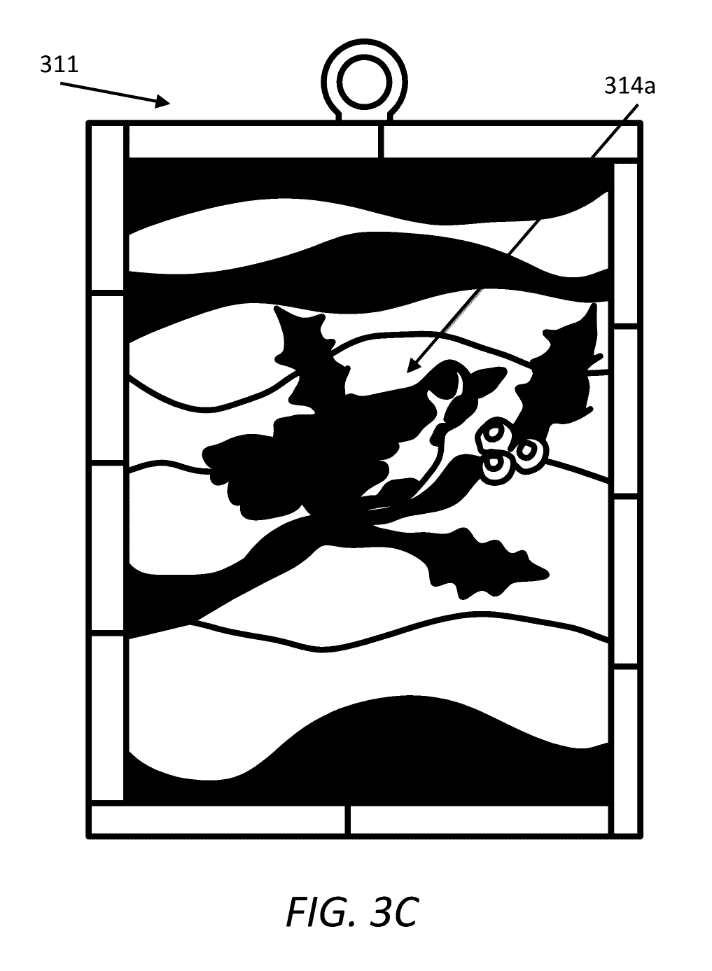

The system 200 includes a first computing device 202 coupled to the rapid prototyping device 201. In some embodiments, the first computing device 202 is a server 122 as described above in connection with FIGS. 1A-B. For example, the first computing device 202 may include one or more devices implementing a cloud computing platform. In other embodiments, the first computing device 202 is a kiosk operated by a user; the kiosk may be a special-purpose device configured to perform the method as described in further detail below in connection with FIG. 3A. In other embodiments, the kiosk is able to communicate directly with a second computing device 204, as described below; for instance, the kiosk may operate in a retail spot, service center, or entertainment venue and users may upload one or more image(s) from a mobile device or other computing device, and select a frame/relief to combine with the one or more images as disclosed further below in reference to FIG. 3A, and order directly from the kiosk.

In still other embodiments, the first computing device 202 includes a personal computer, laptop, or mobile device; for instance, the rapid prototyping device 201 may be able to communicate with a mobile device directly or by means of a network such as the Internet. In some embodiments, the first computing device is configured to receive a two dimensional image file, to merge the two dimensional image file with a file representing a three-dimensional object, producing a three-dimensional print file, and to print, using the rapid prototyping device 201, the three-dimensional print file.

The first computing device 202 may be coupled to a camera 203. The camera 203 may be any device capable of capturing visual data and encoding the visual data in a form usable by a computing device. As a non-limiting example, the camera 203 may be a digital camera. The camera 203 may have one or more lenses used to focus light in order to capture an image or video; for instance, the camera 203 may have a wide-angle lens or a telephoto lens. In some embodiments, the camera is incorporated within the first computing device 202; for example, the first computing device 202 may be a mobile device or personal computer with a built-in camera. Likewise, where the first computing device 202 is or is incorporated in a kiosk as described above, the camera 203 may also be incorporated in the kiosk. The camera 203 may also be separate from the first computing device 202, and coupled to the first computing device 202 by a wired, wireless or network connection.

In some embodiments, the first computing device 202 is incorporated in the rapid prototyping device 201; for instance, the rapid prototyping device 201 may incorporate computing device components usable to perform the method 300 described below, in a manner similar to the computerized components used in some printers and copy machines, such as network-enabled printers. In other embodiments, the first computing device 202 and rapid prototyping device 201 are both incorporated in a larger device such as a kiosk.

The system 200 may include a second computing device 204. The second computing device 204 may be any computing device 100 as described above in reference to FIGS. 1A-B. The second computing device 204 may be another server 122 as described above in connection with FIGS. 1A-B. The second computing device 204 may be a client device 120; for instance the second computing device 204 may belong to a user who has a photograph to use in the method as described in further detail below in connection with FIG. 3A. The second computing device 204 may be a special purpose device, such as a digital camera or photo booth. The second computing device 204 may be coupled to a camera 203 in any manner suitable for coupling the first computing device 202 to a camera 203 as described above in reference to FIG. 2. In other embodiments, the second computing device 204 is a smart phone, tablet, watch, scanner, virtual reality goggles or any device that supports image capture or production.

The system 200 may include a web application (not shown) operating on the first computing device 202 and second computing device 204. The web application may include a server-side program on the first computing device 202. The web application may include a client-side program operating on the second computing device 204. The second computing device 204 may have a specific application written to enact part of the method as described in further detail below; for instance, the second computing device 204 may have a mobile application that is configured to communicate with the first computing device 202.

The system 200 may include at least one remote device 206. The at least one remote device 206 may be any device suitable for use as the first computing device 202 or second computing device 204, as described above in reference to FIG. 2.

FIG. 3A illustrates some embodiments of a method 300 for printing a three-dimensional object incorporating an image. The method 300 includes receiving, by a first computing device coupled to a rapid prototyping device, a two-dimensional image file (301). The method 300 includes merging, by the first computing device, the two-dimensional image file with a file representing a three-dimensional object, producing a three-dimensional print file (302). The method 300 includes printing, by the first computing device, using the rapid prototyping device, the three-dimensional print file (303).

Referring to FIG. 3A in greater detail, and by reference to FIG. 2, the first computing device 202 receives a two dimensional image file (301). In some embodiments, the first computing device 202 receives the two-dimensional image file from a digital camera 203 coupled to the first computing device 202. For instance, the user may take a photograph of the user or another person using the camera 203 and load the photograph onto the first computing device 202 for use as the two-dimensional image. In other embodiments, the first computing device 202 receives the image from a second computing device 204. For instance, the user may take a picture with a camera 203 coupled to the second computing device 204 and send the picture to the first computing device 202; as a non-limiting example, the second computing device 204 may be a mobile device, the user may capture a photograph using the mobile device's built in camera, and a mobile application on the mobile device may convey the resultant image to the first computing device 202. In other embodiments, the second computing device 204 transmits an image stored in the memory of the second computing device 204 to the first computing device 202. For instance, the user may select a photograph from a photo gallery stored on a computer or mobile device, and enter a command to transmit the photograph to the first computing device 202, for instance using a mobile application executing on the second computing device 204. In some embodiments, the two-dimensional image originates from a software program; the software program may be a drawing program. The software program may be a photo manipulation program in which the user retouches or otherwise alters a photograph. The two-dimensional image may be received from any computing device, including devices implementing cloud applications, virtual drive or social networking platforms. The two-dimensional image may originate from a remote device 206, including without limitation a server, a cloud server, or a device in a data center. For instance, a user may enter a command on a device such as first computing device 202 or second computing device 204 directing the first computing device 201 to obtain the two-dimensional image from a social media account, virtual drive, or cloud service account belonging to the user or to another person; as a non-limiting example, the user may use a profile picture or other picture of a person on social media to produce a product according to this method.

The first computing device 202 merges the two-dimensional image file with a file representing a three-dimensional object, producing a three-dimensional print file (302). In some embodiments, the file representing the three-dimensional object is stored in memory accessible to the first computing device 202. In some embodiments, the user selects the file from a plurality of files representing a plurality of 3-dimensional objects. The user may select the file by entering a command directly on the first computing device 202. The user may select the file by entering a command on the second computing device 204. The first computing device 202 may have a curated library of three-dimensional objects. Freelance artists may also submit these objects to the library; in other embodiments, commercial entities such as brand license partners or franchisees may submit files describing objects to the library. In other embodiments, the user enters one or more commands creating the file depicting the three-dimensional object. For example, the user may select a file describing a three-dimensional object, and may enter on or more commands modifying the depicted three-dimensional object; the user may, for instance, add one or more relief features or frame features, or text, as described below, to the three-dimensional object depicted in the file.

The first computing device 202 merges the file describing the three-dimensional object with the two-dimensional image file. The first computing device 202 may merge the file describing the three-dimensional object with the two-dimensional image file by producing a three-dimensional print file in which the two dimensional image is projected onto an exterior surface of the three-dimensional object. In some embodiments, the three-dimensional print file is created by merging of two-dimensional image file and the three-dimensional object file to create an amalgamation of file formats. For instance, the three-dimensional object may be stored in a three-dimensional file format such as wrl/vrml or obj, while the image file that the user uploads may be in a format such as jpeg, tiff, png or some other typical image format; the image format may be superimposed on the at least one surface as a “texture”. Continuing the example, the texture file may be merged into 3D file once the user is satisfied and places their order, and the first computing device 202, or a server in communication with the first computing device 202, may generate a high resoulution three-dimensional print file. In some embodiments, this approach has the advantage that an entirely new file is being created from the merging of two dissimilar files. The three-dimensional print file may be a high-resolution mesh file.

As a non-limiting example, as illustrated in FIGS. 3B-C, the two-dimensional image 310 may be a photograph, such as the photograph of a person's face, and the three-dimensional object 311 may be a souvenir item such as a keychain charm. The three-dimensional object 311 may have one or more faces 312 on which the image 310 may be projected; the one or more faces 312 may be predominantly substantially flat. The three-dimensional print file may describe the three-dimensional object 311 with the image 310 projected on the one or more faces 312. In another embodiment, merging the two-dimensional image file with the three-dimensional object file involves converting the two-dimensional object file to a three-dimensional image object or a relief, and producing a three-dimensional print file in which the three-dimensional image object or relief is a feature of the three-dimensional object; for instance, a relief formed from the face of a person in a photograph may be placed on the at least one surface instead of the image itself. The conversion of the two-dimensional image to a three-dimensional image object or relief may be performed by the first computing device 202 or by an additional computing device.

In some embodiments, merging further involves producing a three-dimensional print file in which a text string 313 is projected onto an exterior surface of the three-dimensional object. In some embodiments, the user selects the text string 313 from a library of text strings. The library of text strings may be curated in memory of the first computing device 202, and added to, as described above for the library of three-dimensional objects. The text string 313 may contain any textual data including, without limitation, written characters from any real or fictional writing system, punctuation, numerical symbols, or any other symbols that may be used in any writing. The text string 313 may have additional attributes; for instance, the text string 313 may be in any font or calligraphic style. The text string 313 may have miniscule or majuscule letters. The text string 313 may have one or more colors. The text string 313 may have any other textual or typographic stylistic effects, such as bolding, italicization, underlining, and the like. The text string 313 may be engraved in an object on which the text string 313 is placed or stand out in relief. The text string 313 may have a font size attribute. Each attribute of the text string 313 may be stored in the entry in the library describing that text string. In other embodiments, the user may select one or more attributes, which are added to the text string before or after the text string is added to the three-dimensional print file. The text string may be projected onto one or more surfaces 312 of the three-dimensional object; the text string 313 may be projected on top of the two-dimensional image 311, or the two-dimensional image 311 may be projected on top of the text string 313.

In other embodiments, the user enters data that is added to the text string 313. The user may enter the text to be included in the text string 313, for instance by typing the text on the second computing device 204, or by similar means; likewise, the user may add text to a pre-existing text string, such as a text string stored in a library by the system 200. The user may enter a command specifying the font of the text string 313. The user may enter a command specifying one or more colors of the text string 313. The user may enter a command specifying one or more calligraphic styles of the text string 313. The user may enter a command specifying one or more other stylistic effects, such as bolding, italicization, underlining, and the like. The user may enter a command specifying the font size of the text. The user may enter a command specifying one or more topographical features of the text string 313, such as whether the text is engraved in the surface of the three-dimensional object or stands out in relief. The user may enter one or more commands dictating the placement of the text string 313 on the three-dimensional object; for instance, the user 313 may use a graphical user interface to place the text string 313 at a desired location on the three-dimensional object. Where the image 311 is projected on a surface 312 of the object, the user may place the text string 313 across the image 310. In some embodiments, the text string 313 varies topographically from the surface 312 on which it is placed. The topographical variation may be that the text string 313 stands out in relief on the surface 312; all of the text string may stand out from the surface, or a portion may stand out. In other embodiments, the topographical variation is such that the text string 313 is engraved within the surface 312; all or part of the text string 313 may be engraved. These features may be combined; a portion of the text string 313 may be in relief while another portion is engraved. The text string 313 may also be differentiated from the surface 312 or image 310 by a contrasting color.

In some embodiments, the three-dimensional print file depicts an object having at least two colors. For example, there may be a main color and a contrast color, permitting dichromatic images, text, and other features. In other embodiments, there are more than two distinct colors, permitting greater variation; the three-dimensional print file may be rendered in enough colors to cover a substantial range of the colors visible to a typical person, so that the image may be in color, for instance, permitting the inclusion of a color photograph as the two-dimensional image 311.

The method 300 includes printing, by the first computing device, using the rapid prototyping device, the three-dimensional print file (303). Where the rapid prototyping device 201 is an additive device, printing may involve producing the object depicted in the three-dimensional print file using an additive process as described above in connection with FIG. 2. Where the rapid prototyping device 201 is a three-dimensional color printer, printing the three-dimensional print file may involve printing an object having at least two colors. For instance, where the exterior of the object depicted in the three-dimensional print file has a plurality of colors, the three-dimensional color printer may print a three-dimensional object having a surface with colors substantially matching the colors of the surface of the object depicted in the three-dimensional print file. The three-dimensional color print file may specify the depth of the colored layers to be printed by the three-dimensional color printer; for instance, the layers may be deep, projecting millimeters or centimeters into the interior of the printed object so that a two-dimensional image on the surface of the object is wear-resistant. The depth may be less than a certain maximal amount to save costs associated with more expensive colored materials. The user may be able to specify the depth using a command entered by the user, for instance via a web application, mobile application, kiosk user interface, or other similar means.

In some embodiments, the first computing device 202 allows the user to see a preview of the object to be printed. The first computing device 202 may display, or cause to be displayed on the second computing device 203, one or more views of the potential object; the one or more views may be comprehensive enough to allow the user to see the potential object's entire exterior surface. In some embodiments, the first computing device 202 produces the views by displaying the three-dimensional print file to the user. In other embodiments, the first computing device 202 creates a separate preview file to display the views to the user; changes to the separate preview file may be made at substantially the same time as changes to the three-dimensional print file, so that, for instance, when the user adds a feature, image, or text to the three-dimensional print file, the user will be able to view the separate preview file to see the effect of the changes. In some embodiments, the separate preview file is a three-dimensional mesh file. The three-dimensional mesh file may be a file produced when the first computing device 202 renders or models what the user constructed. The three-dimensional mesh file may be much lower resolution than the three-dimensional print file. In some embodiments, the three-dimensional print file is produced only after the user has reviewed one or more previews and chosen a final design. The use of a separate preview file may enhance the security of the method; a malicious user or third party that captures the preview file will lack the resolution needed to produce a good quality object. The high-resolution print file may never be shared with any user device, so that it is difficult to steal. Another advantage of the separate preview file is performance: the lower-resolution file may be easy to render, upload, and manipulate for viewing, because it contains less data. Thus, a user may be able to view a preview quickly and easily on a mobile device, even though the print file itself contains too much data to transmit, store, or view practically.

In some embodiments, the lower-resolution preview file is rendered on the first computing device 202. For instance, the rendering may be performed on a cloud server accessed by the second computing device 204 or by a kiosk; as a non-limiting example, the cloud server may receive user instructions rotating the view of the file to be printed, and the cloud server may transmit a view from the rotated angle to the user device. The benefit of this may be that the rendering performance is efferently managed regardless of the user's access device. Likewise, where the process is performed by a cloud server or by a kiosk, the user may not need to obtain software to perform three-dimensional modeling, as the kiosk or cloud server may perform all actual modeling and transmit only two-dimensional views to the user device. In addition, the low-resolution preview may load quickly so the user can swap between different combinations of three-dimensional objects and two-dimensional images without significant rendering delay; many existent three-dimensional modeling programs render high resolution “mesh” files, which can take a long time depending on the available computing power, and may be impossible to render on some user devices, such as smartphones.

In some embodiments, the system 200 transmits one or more snapshots showing views of the preview file to a user device, social media account, or other platform; the user may share the one or more snapshots or use the one or more snapshots as a reference when ordering the final printing process later. In the latter case, the components and parameters may be saved for later reconstruction. In some embodiments, the benefit of saving this data is that the system 200 does not have to save the entire file, which would occupy considerable server space, while allowing the system 200 to quickly present the model in the future for the user to order.

The user may be able to select additional features to include in the printed object. For instance, in some embodiments the first computing device 202 merges a second two-dimensional image file with the three-dimensional print file. The second image may be projected onto a second surface (not shown) of the three-dimensional object. The selection of the second image, and the placement of the second image, may be implemented as described above for the selection and placement of the first image, in connection with FIG. 3A. The second image and first image may overlap each other. As an example, the first image may be a landscape with the second image in the foreground, such that a person depicted in the second image appears to be located in a landscape portrayed in the second image, for instance. The overlap might also be used to create photographic effects such as double or multiple exposures, or three-dimensional images, and the like. The second image may also be a logo, trademark, or similar identifier of a product, service, or commercial entity; where the first computing device 202 is operated by a commercial entity such as a store, a second image identifying the store or a brand therein may be included in all three-dimensional print files.

In other embodiments, the first computing device 202 adds at least one textural element 314a-b to the three-dimensional print file. The at least one textural element may be a relief 314a or engraved pattern. The at least one textural element may include a frame 314b around the two dimensional image in the three-dimensional print file. The at least one textual element may include a pattern on a different surface of the three-dimensional object; for instance, the object to be printed may be substantially two-sided, and may have a textual element representing a pattern on one side and the two-dimensional image on the other side. The at least one textural element may be monochromatic. In other embodiments, the at least one textural element has at least two colors; this may be implemented, and printed, as described above in reference to FIG. 3A. The at least one textural element may also be a logo or other trademark-like object or identifier of a commercial entity or brand. In other embodiments, the first computing device 202 adds at least one pattern of two or more colors to the three-dimensional print file. The at least one pattern may be added in the same manner as the second image, as described above in reference to FIG. 3A.

In some embodiments, the method 300 involves applying a coating layer to an exterior surface of the three-dimensional product. The first computing device 202 may perform this using a coating applicator device 205. In some embodiments, the coating applicator device 205 applies a resin to the three-dimensional product. The resin may be ultraviolet-curable. In some embodiments, the applicator device 205 cures the resin; where the resin is ultraviolet-curable, the applicator device 205 may cure it by bathing the resin in ultra-violet light. The curing process may likewise involve both heating and UV curing, as described above in reference to FIG. 2. In other embodiments, a user performs one or more of the coating steps manually; for instance, the user may manually apply a coating resin and then insert the coated three-dimensional product into a curing oven or similar device for the curing process. In some embodiments, adding the coating enhances and locks in the color of the three-dimensional product, as well as strengthening the three-dimensional product against breakage.

In some embodiments, the first computing device 202 receives a user instruction specifying one or more characteristics of the coating. The user may, for instance, enter a command specifying that the coating have a finish such as a matte, satin, or gloss finish. The user may select textures or degrees of opacity for the coating. In some embodiments, the first computing device 202 provides a set of possible characteristics from which the user may choose, for example with one or more drop-down lists or checklists; the set of possible characteristics may be provided via a user interface on a kiosk, web application, mobile application, or other similar means. The user instructions may be transmitted to a technician performing the coating process. Where the coating process is automated, the first computing device 202 may select coating materials and processes based on the user instructions.

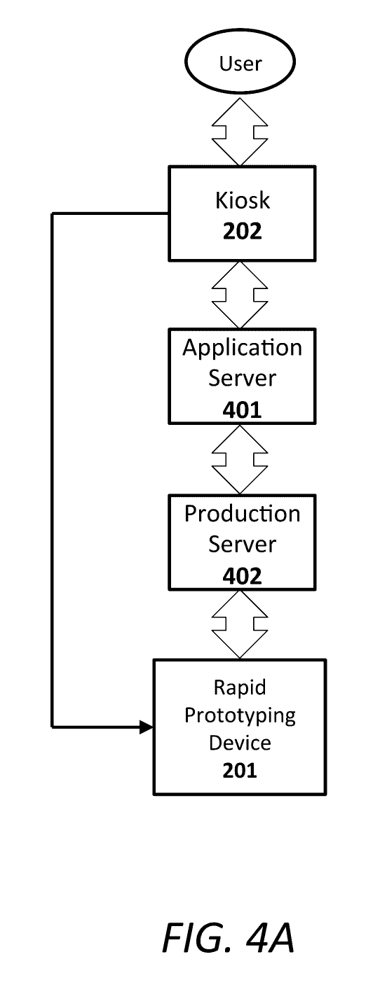

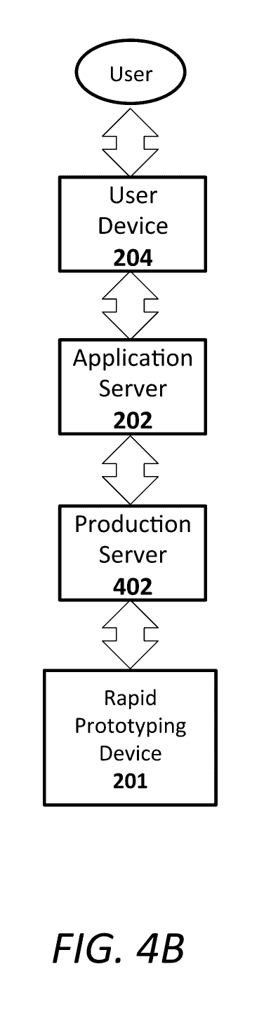

FIG. 4A illustrates an exemplary workflow describing an embodiment of the method that is initiated at a kiosk. The user may enter commands on the kiosk 202. The kiosk 202 may function as a turnkey solution; it may contain the three-dimensional files (potentially including reliefs) and an instance of the web application. It may be able to produce the production files and process the customer order. The kiosk 202 may also function as a point of sales terminal and send the production file directly to the rapid prototyping device 201 for fulfillment. In other embodiments, where the web application implements a thinner client or more cloud-based architecture, the kiosk 202 acts solely as a terminal to access the application server 402 and production server 403, as would a user's computing device.

FIG. 4B similarly shows an exemplary workflow for an embodiment of the method that is initiated at the user device 204. In some embodiments, the user enters commands, for instance via a web application, on the user device 204; in some embodiments, the commands are processed on an application server 202, potentially with the assistance of a production server 402. Preview views or mesh files may be provided to the user via the user device 204 to guide the user's entry of commands. The production server 402 or application server 202 may convey the finalized three-dimensional print file to the rapid prototyping device 201 to produce the object.

Although the foregoing systems and methods have been described in some detail for purposes of clarity of understanding, it will be apparent that certain changes and modifications may be practiced within the scope of the appended claims.

What is claimed is:

1. A method for printing a three-dimensional object incorporating an image, the method comprising:
receiving, by a first computing device coupled to a rapid prototyping device, a two-dimensional image file;
merging, by the first computing device, the two-dimensional image file with a file representing a three-dimensional object, producing a three-dimensional print file; and
printing, by the first computing device, using the rapid prototyping device, the three-dimensional print file to produce a three-dimensional product.

2. The method of claim 1, wherein receiving further comprises receiving, from a camera coupled to the first computing device, the two-dimensional image file.

3. The method of claim 1, wherein receiving further comprises receiving, from a second computing device, the two-dimensional image file.

4. The method of claim 1, wherein merging further comprises producing a three-dimensional print file in which the two-dimensional image is projected onto an exterior surface of the three-dimensional object.

5. The method of claim 1, wherein merging further comprises producing a three-dimensional print file in which a text string is projected onto an exterior surface of the three-dimensional object.

6. The method of claim 5, wherein the text string varies topographically from the surface.

7. The method of claim 6, wherein the text string stands out in relief on the surface.

8. The method of claim 6, wherein the text string is engraved within the surface.

9. The method of claim 1, wherein the three-dimensional print file depicts an object having at least two colors.

10. The method of claim 1, wherein printing further comprises printing an object having at least two colors.

11. The method of claim 1 further comprising merging a second two-dimensional image file with the three-dimensional print file.

12. The method of claim 1 further comprising adding at least one textural element to the three-dimensional print file.

13. The method of claim 12 wherein the at least one textural element comprises a picture frame.

14. The method of claim 12, wherein the at least one textural element comprises a relief design.

15. The method of claim 12, wherein the at least one textural element further comprises at least two colors.

16. The method of claim 1 further comprising adding at least one pattern of two or more colors to the three-dimensional print file.

17. The method of claim 1 further comprising applying a coating layer to an exterior surface of the three-dimensional product.

18. A system for printing a three-dimensional object incorporating an image, the system comprising:
a rapid prototyping device;
a first computing device coupled to the rapid prototyping device, the first computing device configured to receive a two-dimensional image file, to merge the two-dimensional image file with a file representing a three-dimensional object, producing a three-dimensional print file, and to print, using the rapid prototyping device, the three-dimensional print file.

19. The system of claim 18, wherein the rapid prototyping device comprises an additive device.

20. The system of claim 19, wherein the additive device comprises a three-dimensional color printer.
